(19) United States
(12) Patent Application Publication
(10) Pub. No.: US 2020/0223701 A1
(43) Pub. Date: Jul. 16, 2020

(54) PROCESSED GRAPHITE LAMINATED BODY, METHOD FOR MANUFACTURING SAME, AND LASER CUTTING DEVICE FOR PROCESSED GRAPHITE LAMINATED BODY

(71) Applicant: KANEKA CORPORATION, Osaka (JP)

(72) Inventor: Hisanori Morikawa, Hyogo (JP)

(73) Assignee: KANEKA CORPORATION, Osaka (JP)

(21) Appl. No.: 16/833,225

(22) Filed: Mar. 27, 2020

Related U.S. Application Data
(63) Continuation of application No. PCT/JP2018/032388, filed on Aug. 31, 2018.

(30) Foreign Application Priority Data
Sep. 29, 2017 (JP) 2017-190939

(51) Int. Cl. C01B 32/205; B32B 9/00; B32B 9/04

(52) U.S. Cl. CPC C01B 32/205; B32B 9/007; B32B 2310/0843; B32B 2307/732; B32B 2398/20; B32B 9/045

(57) ABSTRACT

A method of producing a processed graphite laminate may include cutting a graphite laminate with use of a laser. The graphite laminate may include two or more graphite layers and a resin layer that is provided between the two or more graphite layers. Each of the two or more graphite layers may have a thickness of not less than 10 μm and not more than 100 μm, and the laser may have a wavelength of not less than 10 nm and not more than 1100 nm.

### TECHNICAL FIELD

One or more embodiments of the present invention relate to a processed graphite laminate, a method of producing a processed graphite laminate, and a laser cutting device for a processed graphite laminate.

### BACKGROUND

Graphite sheets have high electric conductivity, excellent heat resistance, excellent thermal conductivity, and an extremely high Young's modulus. As such, there are expectations regarding the use of graphite sheets in applications such as electrodes, wiring, sensors, vibration plates, reflecting plates, and heat dissipating materials. Graphite sheets may be used in the form of a graphite laminate, in which a plurality of graphite sheets are bonded to each other. Such a graphite laminate can be processed to have a desired shape and size via cutting by use of punching.

Patent Literature 1 discloses a method of processing graphene which includes the steps of: forming graphene on a substrate; and processing the graphene by irradiating desired processing locations with a pulse laser.

### CITATION LIST

### Patent Literature

[Patent Literature 1]

Japanese Patent Application Publication Tokukai No. 2015-843

The inventor of one or more embodiments of the present invention independently discovered, however, that there is room for improvement of graphite laminates obtained with use of punching. In view of this, the inventor researched a method of processing graphite laminates which could be used instead of punching.

Conventional micro-processing techniques such as that described above are intended for graphene whose thickness is that of a single layer of atoms. As such, it has been difficult to apply such conventional techniques to the processing of graphite laminates, which are thicker than graphene.

One or more embodiments of the present invention is to achieve a method of producing a processed graphite laminate in which delamination is prevented or reduced.

### SUMMARY

A method of producing a processed graphite laminate in accordance with one or more embodiments of the present invention includes the step of: cutting a graphite laminate with use of a laser, the graphite laminate including two or more graphite layers and a resin layer provided between the two or more graphite layers, each of the graphite layers having a thickness of not less than 10 μm and not more than 100 μm, the laser have a wavelength of not less than 10 nm and not more than 1100 nm.

A processed graphite laminate in accordance with one or more embodiments of the present invention includes: two or more graphite layers; and a resin layer provided between the two or more graphite layers, each of the graphite layers having a thickness of not less than 10 μm and not more than 100 μm, the graphite layers each having an end part which is at least partially covered with resin, a carbonized material, a graphitized material, or a mixture of these.

A laser cutting device for a processed graphite laminate in accordance with one or more embodiments of the present invention is configured such that a laser has a wavelength of not less than 10 nm and not more than 1100 nm, the processed graphite laminate including two or more graphite layers and a resin layer provided between the two or more graphite layers, each of the graphite layers having a thickness of not less than 10 μm and not more than 100 μm.

One or more embodiments of the present invention makes it possible to provide a processed graphite laminate in which delamination is prevented or reduced.

### BRIEF DESCRIPTION OF DRAWINGS

FIGS. 1A-D illustrate external appearances and cross sections of processed graphite laminates in accordance with Example 1 and Comparative Example 1.

FIGS. 2A-D illustrate cross sections of the processed graphite laminates in accordance with Example 1 and Comparative Example 1.

FIGS. 3A-B illustrate end parts of the processed graphite laminates in accordance with Example 1 and Comparative Example 1.

FIGS. 4A-C are diagrams for explaining an overview of a method of evaluating separation proneness.

FIGS. 5A-B are diagrams for explaining a method of calculating a coverage ratio in FIGS. 3A-B.

### DETAILED DESCRIPTION OF EMBODIMENTS

The following description will discuss in detail, examples of one or more embodiments of the present invention. The present invention is not limited to one or more embodiments described below. Note that any numerical range expressed as “A to B” in the present specification means “not less than A and not more than B” unless otherwise stated. Further, for the purpose of convenience, members that are identical functions are given identical reference signs, and redundant explanations thereof are omitted.

In the following descriptions, a graphite laminate which has not yet been cut by laser cutting or punching may be referred to simply as a “graphite laminate”, and a graphite laminate which has been cut may be referred to as a “processed graphite laminate”.

1. Method of Producing Processed Graphite Laminate

A method of producing a processed graphite laminate in accordance with at least one embodiment of the present invention includes the step of: cutting a graphite laminate with use of a laser, the graphite laminate including two or more graphite layers and a resin layer provided between the two or more graphite layers, each of the graphite layers having a thickness of not less than 10 μm and not more than 100 μm, the laser have a wavelength of not less than 10 nm and not more than 1100 nm.

A graphite sheet has excellent thermal conductivity. Because of this, from common technical knowledge, it has been assumed a graphite sheet irradiated with a laser is prone to spread of heat, and that this would make it difficult to cut the graphite sheet to a desired shape. For this reason, conventionally, graphite sheets have been typically processed via punching. However, through research, the inventor of the present disclosure found that during punching, when the punching blade returns to its original position after passing through the graphite sheet, an end part of the graphite sheet may be bent. This can cause the layers of a processed graphite laminate to be prone to separation. Through diligent research, the inventor of the present disclosure found that it is possible to process a graphite laminate with use of a laser having a specific wavelength, and that it is possible to obtain a processed graphite laminate in which delamination is prevented or reduced.

1-1. Graphite Laminate

Discussed first is a graphite laminate which is to be cut via the above-described method of production. The graphite laminate includes at least two graphite layers and a resin layer provided therebetween. In other words, the graphite laminate includes a structure in which a graphite layer, a resin layer, and another graphite layer are disposed in this order. This structure serves as a minimum unit. The graphite laminate may consist of only this minimum unit. Alternatively, the graphite laminate may have one or more other graphite layer(s) and/or resin layer(s) disposed outwardly of this minimum unit.

The outward-most layers of the graphite laminate may each be a graphite layer or a resin layer. Graphite layers may serve as the outward-most layer on both sides of the graphite laminate, and resin layers may serve as the outward-most layer on both sides of the graphite laminate. The graphite laminate may also be configured such that the outward-most layer on one side is a graphite layer, and the outward-most layer on the other side is a resin layer.

The graphite layers and resin layers may be provided in an alternating manner. One graphite layer and one resin layer may be provided in an alternating manner. A set of two or more graphite layers and a set of two or more resin layers may be provided in an alternating manner. One graphite layer and a set of two or more resin layers may be provided in an alternating manner. One resin layer and a set of two or more graphite layers may be provided in an alternating manner.

In one or more embodiments, the total number of layers in the graphite laminate is not less than 3 and not more than 19, and not less than 5 and not more than 13. Having a total number of layers falling within the above ranges allows the graphite laminate to have excellent thermal conductivity and excellent mechanical strength. In one or more embodiments the number of graphite layers in the graphite laminate is not less than 2 and not more than 10, and not less than 4 and not more than 7. The number of resin layers in the graphite laminate is not less than 1 and not more than 9, and not less than 3 and not more than 6.

In one or more embodiments, the graphite laminate has a thickness of not less than 50 μm, and not less than 100 μm. Having a thickness of not less than 50 μm allows the graphite laminate to have excellent thermal conductivity and excellent mechanical strength.

The graphite layers may each consist of only a graphite sheet. Each graphite layer has a thickness of not less than 10 μm and not more than 100 μm, and not less than 20 μm and not more than 50 μm. Setting the thickness of each graphite layer to be not less than 10 μm makes it possible to form a graphite laminate that is thick even with a relatively small number of layers. Setting the thickness of each graphite layer to be not more than 100 μm makes it possible to form a graphite laminate having a higher thermal conductivity.

In one or more embodiments, the graphite layers each have a density that is not less than 1.80 g/cm³ and not more than 2.26 g/cm³. If there is a reduced density due to defects or voids inside a graphite layer, the graphite laminate becomes prone to formation of burrs during cutting, which burrs originate from the defects or voids. In view of this, one or more embodiments of the density of each graphite layer is not less than 1.80 g/cm³, not less than 1.85 g/cm³, and not less than 1.99 g/cm³.

The thermal conductivity of the graphite layers is as high as possible in one or more embodiments. Due to recent space savings and advances in performance achieved in electronic devices, there is a need for materials which spread heat generated by an integrated circuit throughout a housing. As such, in one or more embodiments, the graphite layers each have a thermal conductivity which is equal to or greater than that of copper (400 W/mK). In one or more embodiments, the graphite layers each have a thermal conductivity which is not less than 500 W/mK, not less than 600 W/mK, not less than 800 W/mK, and not less than 1000 W/mK.

In view of dissipation of heat generated by e.g. an integrated circuit, one or more embodiments of the graphite layers each have an electric conductivity which is not less than 5000 S/cm, not less than 6000 S/cm, not less than 7000 S/cm, and not less than 8000 S/cm.

Each of the resin layers can be a thermoplastic resin layer or a curable resin layer. Each of the resin layers can be a bonding layer or a protective layer. One or more embodiments of each resin layer has a thickness of not less than 1 μm and not more than 20 μm, and not less than 1 μm and not more than 15 μm. Setting the thickness of each resin layer to be not more than 20 μm avoids impairment of heat transfer between graphite layers and enables favorable transmission of heat. Setting the thickness of each resin layer to be not less than 1 μm makes it possible to reduce contact thermal resistance between graphite layers and resin layers, and enables efficient transmission of heat. Setting the thickness of each resin layer to be not less than 1 μm also allows the resin layers to have favorable adhesiveness and a favorable protective property. Setting the thickness of each resin layer to be within the above ranges allows the graphite laminate to have a thermal conductivity which is close to the theoretical value.

Examples of thermoplastic resins which can be contained in the thermoplastic resin layer include acrylic resin, ionomer, isobutylene maleic anhydride copolymer, acrylonitrile-acryl-styrene copolymer (AAS), acrylonitrile-ethylene-styrene copolymer (AES), acrylonitrile-styrene copolymer (AS), acrylonitrile-butadiene-styrene copolymer (ABS), acrylonitrile-chlorinated polyethylene-styrene copolymer (ACS), methyl methacrylate-butadiene-styrene copolymer (MBS), ethylene-vinyl chloride copolymer, ethylene-vinyl acetate copolymer (EVA), ethylene-vinyl acetate copolymer (EVA)-based resin, ethylene vinyl alcohol copolymer (EVOH), polyvinyl acetate, chlorinated vinyl chloride, chlorinated polyethylene, chlorinated polypropylene, carboxy vinyl polymer, ketone resin, norbornene resin, vinyl propionate, polyethylene (PE), polypropylene (PP), polymethylpentene (TPX), polybutadiene, polystyrene (PS), styrene-maleic anhydride copolymer, methacrylic resin, ethylene-methacrylic acid copolymer (EMAA), polymethylmethacrylate (PMMA), polyvinyl chloride (PVC), polyvinylidene chloride, polyvinyl alcohol (PVA), polyvinyl ether, polyvinyl butyral, polyvinyl formal, cellulose-based resin, nylon 6, nylon 6 copolymer, nylon 66, nylon 610, nylon 612, nylon 11, nylon 12, copolymer nylon, nylon MXD, nylon 46, methoxymethylated nylon, aramid, polyethylene terephthalate (PET), polybutylene terephthalate (PBT), polycarbonate (PC), polyacetal (POM), polyethylene oxide, polyphenylene ether (PPE), modified PPE, polyether ether ketone (PEEK), polyether sulfone (PES), polysulfone (PSO), polyamine sulfone, polyphenylene sulfide (PPS), polyarylate (PAR), poly-para-vinyl phenol, poly-para-methylene styrene, polyallylamine, aromatic polyester, liquid crystal polymer, polytetrafluoroethylene (PTFE), tetrafluoroethylene-ethylene copolymer (ETFE), tetrafluoroethylene-hexafluoropropylene copolymer (FEP), tetrafluoroethylene-hexafluoro propylene-perfluoroalkyl vinyl ether copolymer (EPE), tetrafluoroethylene-perfluoroalkyl vinyl ether copolymer (PFA), polychlorotrifluoroethylene copolymer (PCTFE), ethylene-chlorotrifluoroethylene copolymer (ECTFE), polyvinylidene fluoride (PVDF)-based resin, polyvinyl fluoride (PVF), polyethylene naphthalate (PEN), and polyester-based resin.

Out of these examples, the thermoplastic resin layer is made of an aromatic material (for example, polyester-based resin or polyethylene terephthalate). Such an arrangement allows thermoplastic resin layers to be aligned substantially parallel to the surfaces of the graphite layers. This prevents the graphite layers from becoming misaligned when disposed. As a result, it is possible to obtain a graphite laminate whose thermal conductivity is close to the theoretical value. In one or more embodiments of the above examples, the thermoplastic resin layer is a thermoplastic polyester resin layer.

In one or more embodiments, the thermoplastic resin has a glass transition point of not less than 50° C., not less than 60° C., not less than 70° C., and not less than 80° C. Using a thermoplastic resin whose glass transition point is not less than 50° C. makes it possible to more effectively prevent air from remaining in the graphite laminate. Using a thermoplastic resin layer whose glass transition point is not less than 50° C. also allows the thermoplastic resin layer to have a high strength and renders the thermoplastic resin layer unlikely to have property variations. Examples of materials having such a glass transition point include PET, PS, and PC.

The thermoplastic resin layer is not particularly limited with regard to elastic modulus. In one or more embodiments, the elastic modulus is, however, not less than 100 MPa, to reduce variations in thickness that may occur during cutting.

Curable resins that may be contained in the curable resin layer are not particularly limited. Examples of such curable resins include epoxy resin, oxetane resin, unsaturated polyester resin, vinylester resin, acrylate resin, phenol resin, cyanate ester resin, urethane resin, and polyether resin having a hydrolyzable silyl group.

1-2. Cutting Step

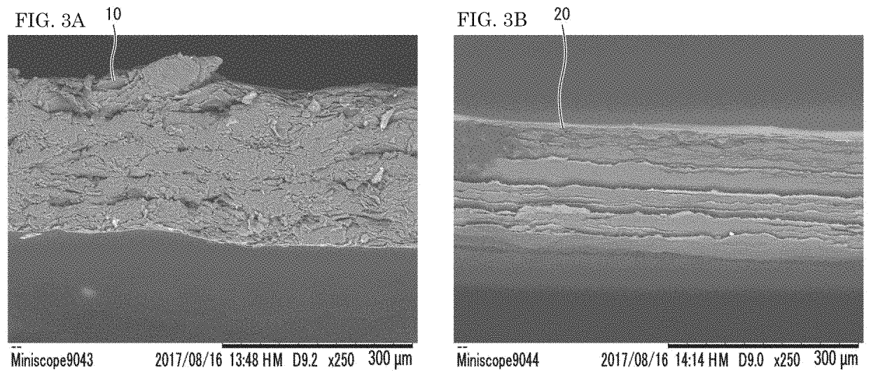

The above-described method of production includes a step of cutting the graphite laminate with use of a laser. This step is also referred to as a cutting step herein. In the above-described method of production, the graphite laminate is cut with use of a laser having a specific wavelength. This makes it possible to obtain a processed graphite laminate in which the end parts of the graphite layers are covered by resin, a carbonized material, a graphitized material, or a mixture of these, as illustrated in FIG. 3A (described later). As such, the above-described method of production makes it possible to obtain a processed graphite laminate in which delamination is prevented or reduced.

In one or more embodiments, the wavelength of the laser is not less than 10 nm and not more than 1100 nm, not less than 300 nm and not more than 600 nm, and not less than 350 nm and not more than 550 nm. Setting the wavelength to be not more than 1100 nm reduces diffusion of heat from the laser and thus makes it possible to cut the graphite laminate. Setting the wavelength to be not less than 10 nm makes it possible to cut the graphite laminate with a certain level of output power. Note that in cases where a long time is required for laser cutting, the effects of heat tend to make scorched portions and burrs more likely to occur. Setting the wavelength to be not less than 300 nm and not more than 600 nm reduces the length of time required for cutting and thus makes it possible to obtain a processed graphite laminate in which scorched portions and burrs are prevented or reduced.

Examples of lasers having such a wavelength include an yttrium aluminum garnet (YAG) laser, an yttrium vanadium tetraoxide (YVO₄) laser, a fiber laser, and a semiconductor laser. In one or more embodiments of these lasers, the YAG laser allows for a relatively high output power when the wavelength is not less than 300 nm and not more than 600 nm.

In one or more embodiments, a case where the wavelength of the laser is not less than 300 nm and not more than 600 nm, the following processing conditions are present.

The laser has an output power at a point of processing (hereinafter, “processing point output power”) which, in one or more embodiments, is not less than 4 W and not more than 70 W, and not less than 4 W and not more than 65 W. Setting the processing point output power to be not less than 4 W makes it possible to cut the graphite laminate quickly. Setting the processing point output power to be not more than 70 W reduces the effects of heat. As such, setting the processing point output power to be not less than 4 W and not more than 70 W makes it possible to increase the speed of processing and obtain a processed graphite laminate in which scorched portions and burrs are prevented or reduced. The processing point output power can be measured via the measurement method described in the Examples (described later).

In one or more embodiments, the laser has a beam diameter of not less than 5 μm and not more than 50 μm, and not less than 7 μm and not more than 50 μm. Setting the beam diameter to be not less than 5 μm makes it possible to cut the graphite laminate quickly. Setting the beam diameter to be not more than 50 μm reduces the effects of heat. As such, setting the beam diameter to be not less than 5 μm and not more than 50 μm makes it possible to obtain a processed graphite laminate in which scorched portions and burrs are prevented or reduced.

In one or more embodiments, the laser has a frequency of not less than 10 kHz and not more than 250 kHz, and less than 10 kHz and not more than 240 kHz. Setting the frequency to be not less than 10 kHz makes it possible to increase the speed of processing. Setting the frequency to be not more than 250 kHz increases pulse energy and therefore makes it possible to cut thicker graphite sheets.

In order to prevent or reduce scorched portions and burrs and also cut thick graphite sheets, the laser in one or more embodiments is a pulse laser. The laser has a pulse energy of not less than 0.10 mJ and not more than 1.30 mJ, and not less than 0.13 mJ and not more than 0.90 mJ. Setting the pulse energy to be not less than 0.10 mJ makes it possible to cut the graphite sheets more quickly. Setting the pulse energy to be not more than 1.30 mJ makes it possible to prevent or reduce scorched portions and burrs while cutting.

In one or more embodiments, the laser has an energy density of not less than 50 mJ/mm² and not more than 10000 mJ/mm², and not less than 50 mJ/mm² and not more than 8000 mJ/mm². Setting the energy density to be not less than 50 mJ/mm² makes it possible to cut thicker graphite sheets more quickly. Setting the energy density to be not more than 10000 mJ/mm² makes it possible to prevent or reduce scorched portions and burrs while cutting. The energy density is calculated by dividing the pulse energy by the beam diameter.

In one or more embodiments, the laser processing speed is not less than 2 mm/s and not more than 200 mm/s, and not less than 2 mm/s and not more than 180 mm/s. Setting the laser processing speed to be not less than 2 mm/s makes it possible to perform cutting within an amount of time such that productivity is not compromised. Setting the laser processing speed to be not more than 200 mm/s makes it possible to cut thicker graphite sheets. The laser processing speed can be measured via the measurement method described in the Examples (described later).

Step of Preparing Graphite Laminate

The above-described method of production may further include a step of preparing a graphite laminate. The graphite laminate may be prepared by providing commercially available graphite sheets and resin film(s) in a layered manner. During this step, it is at least one embodiment to apply pressure to a stack of the graphite sheets and resin film(s), in order to strongly bond the graphite sheet and the resin film(s). It is also an embodiment to apply heat concurrently with the pressure. The softening of bonding layer(s) due to the heat applied, and the effects of the pressure applied make it possible to prevent or reduce air remaining in the graphite laminate. This makes it possible to reduce the contact thermal resistance between the graphite sheets.

Examples of the graphite sheet include natural graphite, a graphite sheet obtained by heat treatment of a polymer material, and highly oriented pyrolytic graphite. Out of these examples of the graphite sheet, the graphite sheet obtained by heat treatment of a polymer material is has one or more embodiments of thermal conductivity and mechanical strength. The above method of production may include a step of obtaining a graphite sheet by heat treating a film made from a polymer material (such a film hereinafter also referred to as a “polymer film”).

In one or more embodiments, the polymer material is an aromatic polymer. The aromatic polymer is at least one polymer selected from polyamides, polyimides, polyquinoxaline, polyparaphenylene vinylene, polyoxadiazole, polybenzimidazole, polybenzoxazole, polybenzthiazole, polyquinazolinedione, polybenzoxazinone, polyquinazolone, benzimidazobenzophenanthroline ladder polymer, and derivatives of these polymers. A film made of these polymer materials can be produced by a publicly known method. Examples of polymer materials include aromatic polyimides, polyparaphenylene vinylene, and polyparaphenylene oxadiazole. In one or more embodiments, the polymer material is an aromatic polyimide. In one or more embodiments, the polymer material is an aromatic polyimide that is produced from a polyamide acid obtained from (i) an acid dianhydride (in particular, an aromatic acid dianhydride) and (ii) a diamine (in particular, an aromatic diamine).

In one more embodiments, the polymer film is carbonized by preheating in an inert gas or in a vacuum. In at least one embodiment, the inert gas is nitrogen, argon, or a mixture of argon and nitrogen. The preheating is ordinarily carried out at approximately 1000° C. A temperature increase rate used until the preheating temperature is reached is not particularly limited. One example of the temperature increase rate is 5° C./minute to 15° C./minute. During the preheating, in order to prevent the polymer film from losing orientation, it occurs in at least one or more embodiments to apply a vertical pressure to a film surface to an extent that the film does not break.

In one or more embodiments, the film carbonized via the above method (hereinafter also referred to as a “carbonized film”) is set in a high-temperature furnace and graphitized. In at least one embodiment, carbonized film is set by being sandwiched between cold isostatic pressing materials (CIP materials) or substrates made of glassy carbon. Carrying out graphitization at a temperature of not less than 2400° C. makes it possible to obtain a graphite sheet having a surface-direction-wise thermal conductivity of not less than 500 W/mK.

In one or more embodiments, maximum temperature during graphitization is not less than 2400° C., not less than 2600° C., and not less than 2800° C. The graphite sheet obtained may be subjected to further heat treatment by annealing. Such a high temperature is ordinarily produced by directly applying an electric current to a graphite heater and using Joule heat of the graphite heater to carry out heating. The graphitization can be carried out in an inert gas. Argon is most suitable as the inert gas. A small amount of helium may be added to the argon. A higher treatment temperature allows conversion into higher quality graphite. However, it is also possible to obtain a superior graphite sheet even with a treatment temperature of, for example, not higher than 3700° C., or, particularly, not higher than 3600° C. or not higher than 3500° C.

A time for which the maximum temperature is maintained is, for example, not less than 10 minutes, and not less than 30 minutes. The time for which the maximum temperature is maintained may be 1 hour or more. An upper limit of the time for which the maximum temperature is maintained is not particularly limited, but ordinarily may be 10 hours or less, and particularly 5 hours or less.

2. Processed Graphite Laminate

A processed graphite laminate in accordance with at least one embodiment of the present invention includes: two or more graphite layers; and a resin layer provided between the two or more graphite layers, each of the graphite layers having a thickness of not less than 10 μm and not more than 100 μm, the graphite layers each having an end part which is at least partially covered with resin, a carbonized material, a graphitized material, or a mixture of these. The processed graphite laminate can be obtained via the above-described method of producing a processed graphite laminate. The following descriptions will omit matters already described in the section “1. Method of Producing Processed Graphite Laminate” above.

When the graphite laminate is cut with use of a laser as described above, heat from the laser melts a portion of the resin included in the resin layer(s) of the graphite laminate. This melted resin comes out from between the graphite layers. The melted resin is further carbonized or graphitized. Herein, resin which has been carbonized thusly and which contains a large amount of the element carbon is referred to as “carbonized material”. Furthermore, resin which has been graphitized is referred to as “graphitized material”. As such, the graphite layers of the processed graphite laminate have end parts that are covered by a resin, a carbonized material, a graphitized material, or a mixture of these, and thus the end parts of the graphite layer are integrated with each other. An example of end parts of such a processed graphite laminate is illustrated in FIG. 3A (described later). The configuration in which end parts of two or more graphite layers are at least partially covered with resin, a carbonized material, a graphitized material, or a mixture of these prevents or reduces delamination. Delamination refers to separation of any of the graphite layers or resin layer(s) included in the processed graphite laminate.

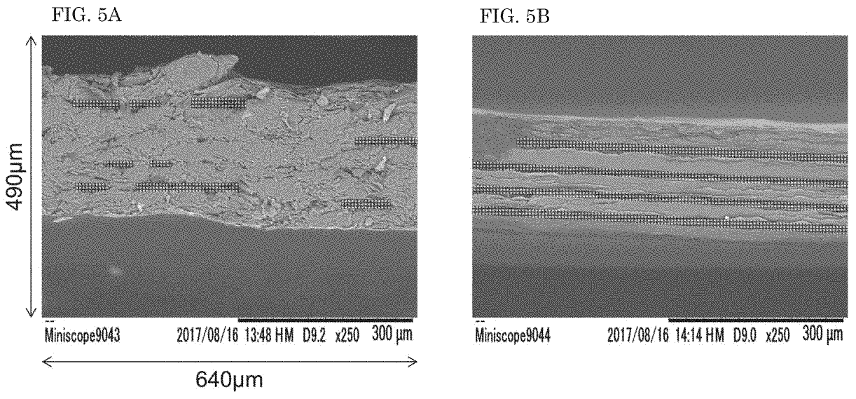

Herein, the phrase “end parts of two or more graphite layers are at least partially covered with resin, a carbonized material, a graphitized material, or a mixture of these” refers to a coverage ratio of not less than 20%, as calculated in the manner described below. First, a discretionarily chosen region (width: 640 μm, height: 490 μm) that includes a cross-section obtained by laser cutting is observed head-on with use of a scanning electron microscope. The width is along a direction parallel to a boundary between graphite layers. The height is along a direction perpendicular to the width. Herein, the coverage ratio refers to a ratio of (a) a widthwise length of regions of the boundary (or boundaries) between the graphite layers which are covered by resin, a carbonized material, a graphitized material, or a mixture of these, to (b) the total widthwise length of the boundary (or boundaries) between the graphite layers, each length being in the region that is observed as described above. In other words, the ratio of (a) the widthwise length of the regions of the boundary (or boundaries) which are covered by resin, a carbonized material, a graphitized material, or a mixture of these, to (b) a length calculated as (640 μm×number of boundaries) is not less than 20%. The phrase “regions of the boundary (or boundaries) which are covered by resin, a carbonized material, a graphitized material, or a combination of these” refers to regions of any boundary between graphite layers (in the observed region) which regions are covered with resin, a carbonized material, a graphitized material, or a mixture of these. The coverage ratio is, in one or more embodiments, not less than 50%, not less than 70%, and 100%. A coverage ratio of 73% is illustrated in FIG. 5A (described later). A more specific method of calculating the coverage ratio will be described later with reference to the Examples.

Note that the covering material may be any one of resin, a carbonized material, and a graphitized material. The covering material may be a mixture of these. Because the resin, the carbonized material, the graphitized material, and mixtures of these are nearly identical in composition, there are cases where it is difficult to determine which one of these is the covering material.

In one or more embodiments, end parts of graphite layers included in the processed graphite laminate are completely covered by resin, a carbonized material, a graphitized material, or a mixture of these. The processed graphite laminate have graphite layers whose end parts are integrated with each other. In other words, the laminated structure of the processed graphite laminate is unclear at the end parts. This makes it possible to prevent or reduce delamination.

In one or more embodiments of the processed graphite laminate, the width of a scorched portion at the end parts is less than 300 μm, and less than 100 μm. Herein, “scorched portion” refers to a region which has turned black in color due to heat from the laser. The width of scorched portions can be measured via the measurement method described in the Examples (described later).

3. Laser Cutting Device for Processed Graphite Laminate

A laser cutting device for a processed graphite laminate in accordance with at least one embodiment of the present invention is configured such that a laser has a wavelength of not less than 10 nm and not more than 1100 nm, the processed graphite laminate including two or more graphite layers and a resin layer provided between the two or more graphite layers, each of the graphite layers having a thickness of not less than 10 μm and not more than 100 μm. The laser cutting device for a processed graphite laminate is a device which can be used in the above-described method of producing the processed graphite laminate. In other words, the laser cutting device for a processed graphite laminate is a device which can be used for producing the above-described processed graphite laminate. As such, the matters described in the sections “1. Method of Producing Processed Graphite Laminate” and “2. Processed Graphite Laminate” above can be applied as necessary to the laser cutting device in accordance with one or more embodiments of the present invention.

The present invention is not limited to one or more embodiments, but can be altered by a skilled person in the art within the scope of the claims. One or more embodiments of the present invention also encompasses, in its technical scope, any embodiment derived by combining technical means disclosed in differing embodiments.

A method of producing a processed graphite laminate in accordance with at least one embodiment of the present invention includes the step of: cutting a graphite laminate with use of a laser, the graphite laminate including two or more graphite layers and a resin layer provided between the two or more graphite layers, each of the graphite layers having a thickness of not less than 10 μm and not more than 100 μm, the laser have a wavelength of not less than 10 nm and not more than 1100 nm.

In one or more embodiments of the present invention, the method of producing the processed graphite laminate may be adjusted such that the laser has a wavelength of not less than 300 nm and not more than 600 nm.

In one or more embodiments of the present invention, the method of producing the processed graphite laminate may be adjusted such that the laser has a processing point output power of not less than 4 W and not more than 70 W.

In one or more embodiments of the present invention, the method of producing the processed graphite laminate may be adjust such that the laser has a beam diameter of not less than 5 μm and not more than 50 μm.

In one or more embodiments of the present invention, the method of producing the processed graphite laminate may be adjusted such that the resin layer is a thermoplastic resin layer.

A processed graphite laminate in accordance with one or more embodiments of the present invention includes: two or more graphite layers; and a resin layer provided between the two or more graphite layers, each of the graphite layers having a thickness of not less than 10 μm and not more than 100 μm, the graphite layers each having an end part which is at least partially covered with resin, a carbonized material, a graphitized material, or a mixture of these.

In one or more embodiments of the present invention, the processed graphite laminate may be configured such that the resin layer is a thermoplastic resin layer.

In one or more embodiments of the present invention, the processed graphite laminate may be configured such that the thermoplastic resin layer is a thermoplastic polyester resin layer.

A laser cutting device for a processed graphite laminate in accordance with one or more embodiments of the present invention is configured such that a laser has a wavelength of not less than 10 nm and not more than 1100 nm, the processed graphite laminate including two or more graphite layers and a resin layer provided between the two or more graphite layers, each of the graphite layers having a thickness of not less than 10 μm and not more than 100 μm.

### EXAMPLES

The following description will discuss one or more embodiments of the present invention in more detail with reference to Examples. Note, however, that one or more embodiments present invention is not limited to these Examples.

(1) Evaluation of Separation Proneness

### Production Example 1

A polyimide film (polyimide manufactured by Kaneka Corporation; Apical AH) measuring 20 m in length, 250 mm in width, and 75 μm in thickness was wound around a cylindrical carbonaceous core whose outer diameter was 150 mm. The polyimide film was then subjected to a carbonizing treatment (carbonization) with use of an electric furnace and under a nitrogen atmosphere, by heating the polyimide film to 1000° C. and then performing heat treatment at 1000° C. for 1 hour. Next, the film thus carbonized was graphitized with use of an ultra-high-temperature furnace and under an argon atmosphere, by heating the film to 2800° C. and maintaining that maximum temperature for 1 hour. Thereafter, the graphitized film was cooled, such that a graphite sheet measuring 18 m in length, 225 mm in width, and 40 μm in thickness was obtained.

### Example 1 and Comparative Example 1

The above graphite sheet and a PET sheet (thickness: 5 μm) were cut to a desired size and disposed such that single layers of each were arranged in an alternating manner. Five layers of the graphite sheet and four layers of the PET sheet were disposed, such that graphite sheets served as the outward-most layers. Pressure (3 MPa) and heat (270° C.) were applied simultaneously to the stack thus produced, such that the layers were bonded to each other. In this way, a graphite laminate made of five graphite layers and four resin layers was obtained. The graphite laminate had a length of 260 mm, a width of 210 mm, and a thickness of 170 μm.

The graphite laminate was then cut with use of either a YAG laser (wavelength: 532 nm) or a cutting press (punching) so as to obtain individual processed graphite laminates each of which was 70 mm in length, 14 mm in width, and 170 μm in thickness. The processed graphite laminates obtained using the YAG laser were used as Example 1, and the processed graphite laminates obtained using the cutting press were used as Comparative Example 1.

Evaluation Method

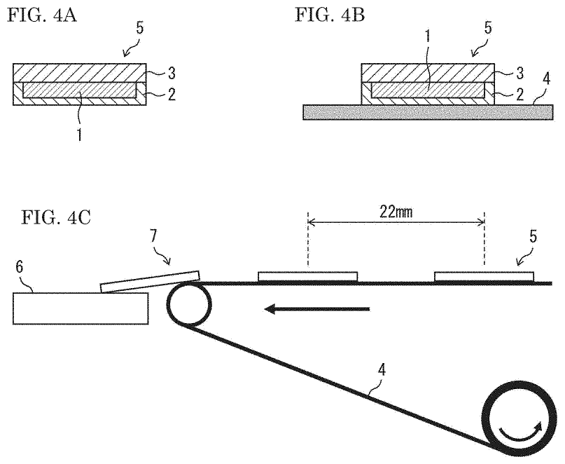

The processed graphite laminates of Example 1 and Comparative Example 1 were evaluated for proneness to separation. FIGS. 4A-C are diagrams illustrating an overview of a method of evaluating separation proneness. To a surface of a processed graphite laminate 1 (length: 70 mm, width: 14 mm, thickness: 170 μm) was affixed a piece of double-sided acrylic tape 2 (length: 71 mm, width: 15 mm, thickness: 5 μm). The double-sided acrylic tape 2 was affixed in a manner such that no part of the processed graphite laminate 1 extended past the double-sided acrylic tape 2. Further, a PET protective film 3 (length: 71 mm, width: 15 mm, thickness: 70 μm) was affixed to the other surface of the processed graphite laminate 1, i.e., to the surface on which the double-sided acrylic tape 2 was not affixed. The PET protective film 3 was affixed such that no part of the processed graphite laminate 1 extended past the PET protective film 3. In this way, a composite unit 5 made up of the double-sided acrylic tape 2, the processed graphite laminate 1, and the PET protective film 3 was obtained, as illustrated in FIG. 4A.

A PET film 4 (width: 100 mm, thickness: 40 μm) prone to separation was let out from a roll consisting of the PET film 4. One-hundred (100) of the composite units 5 were affixed to the PET film 4 at 22 mm intervals. The side of the composite units 5 having the double-sided acrylic tape 2 was affixed to the PET film 4, as illustrated in FIG. 4B. In this way, a PET film roll onto which the composite units 5 were affixed was obtained.

The PET film 4 with the composite units 5 affixed thereto was then let out from the PET film roll, as illustrated in FIG. 4C. Composite units 7 which separated from the PET film 4 were received on a receiving platform 6. The end parts of the processed graphite laminates 1 in these composite units 7 were visually observed. The end part of the processed graphite laminate 1 was observed for presence of bending due to delamination.

Results of Evaluation

The results of the evaluation are as follows.

Comparative Example 1: Bending (delamination) in 23 processed graphite laminates
Example 1: Bending (delamination) in 0 processed graphite laminates

These results indicate that delamination is prevented or reduced in a processed graphite laminate that has been cut with use of a laser having a specific wavelength.

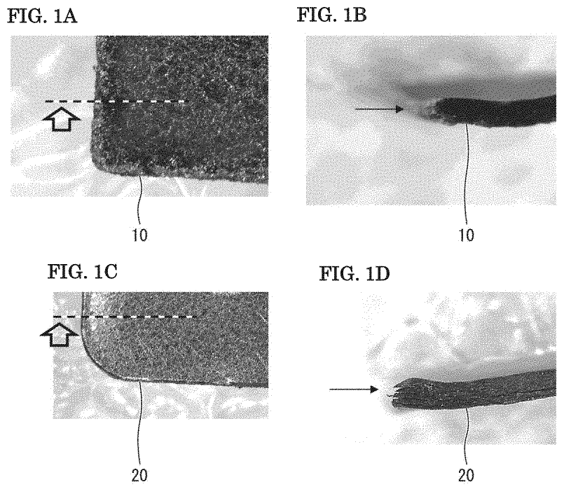

The end parts of processed graphite laminates of Example and Comparative Example 1 were observed. FIGS. 1A-D illustrate external appearances and cross sections of the processed graphite laminates in accordance with Example 1 and Comparative Example 1. A processed graphite laminate 10 of Example 1 was cut with scissors along the dotted line as shown in FIG. 1A. The cross-section at the dotted line, as observed from the direction indicated by the arrow, is illustrated in FIG. 1B. Note that the arrow in FIG. 1B points to an end part cut by a laser. FIG. 1C illustrates an external appearance of a processed graphite laminate 20 of Comparative Example 1. FIG. 1D shows a cross-section of the processed graphite laminate 20 of Comparative Example 1 in a manner similar to FIG. 1B. The arrow in FIG. 1D points to an end part cut by a cutting press. In Example 1, the laminated structure of the end part is unclear, as illustrated in FIG. 1B. In contrast, in Comparative Example 1, the laminated structure of the end part is clearly seen, as illustrated in FIG. 1D. This is presumably what prevented delamination in Example 1.

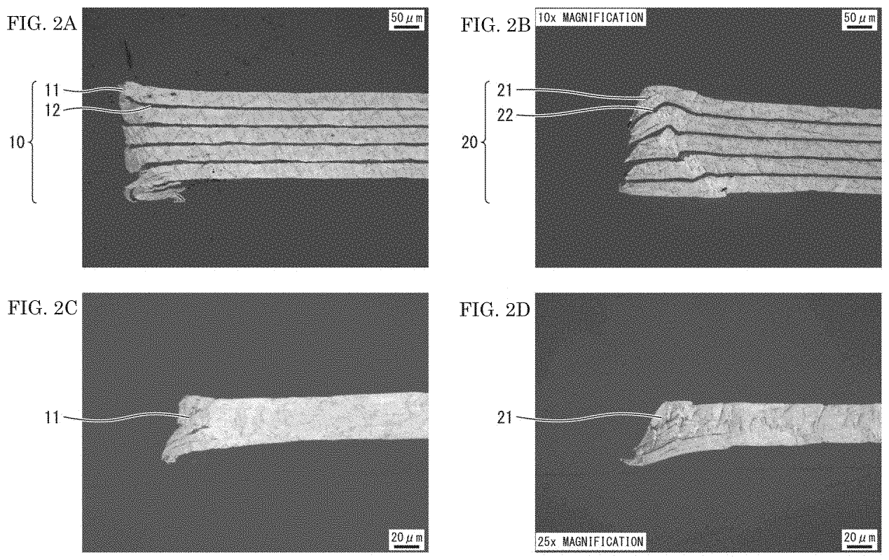

FIGS. 2A-D illustrate cross sections of the processed graphite laminates in accordance with Example 1 and Comparative Example 1. FIG. 2A is an enlarged view of FIG. 1B. The processed graphite laminate 10 is formed from graphite layers 11 and resin layers 12 disposed in an alternating manner. Similarly, FIG. 2B is an enlarged view of FIG. 1D. The processed graphite laminate 20 is formed from graphite layers 21 and resin layers 22 disposed in an alternating manner. FIGS. 2C-D are enlarged views of the one of the graphite layers 11 and one of the graphite layers 21, respectively.

FIGS. 3A-B illustrate end parts of the processed graphite laminates in accordance with Example 1 and Comparative Example 1. FIGS. 3A-B illustrate end parts as observed with a scanning electron microscope, from the directions indicated by the arrows in FIGS. 1B-D, respectively. As illustrated in FIG. 3A, each graphite layer in Example 1 is covered by resin, a carbonized material, a graphitized material, or a mixture of these. In contrast, in Comparative Example 1, the laminated structure of the end part is clearly seen, as illustrated in FIG. 3B.

FIGS. 5A-B are diagrams for explaining a method of calculating the coverage ratio of the region illustrated in FIGS. 3A-B. FIGS. 5A-B illustrate the same regions shown in FIGS. 3A-B, respectively. The size of each of these regions is 640 μm in width by 490 μm in height. The crosshatched portions in FIGS. 5A-B indicate regions of borders between graphite layers which regions are observable and continuous in the widthwise direction (i.e., regions of borders which are not covered). The processed graphite laminates of Example 1 and Comparative Example 1 each have five graphite layers, and thus there are four borders between graphite layers in each processed graphite laminate. As such, in each of FIGS. 5A-B, the total widthwise length of borders between graphite layers is 640×4 μm. In this case, the coverage ratio is calculated as follows.

Coverage ratio={1−(total widthwise length of crosshatched portions)/(640×4)}×100

Using this formula, the coverage ratios of Example 1 and Comparative Example 1 were found to be 73% and 3%, respectively.

(3) Evaluation of Processability

Examples 2 to 12 and Comparative Examples 2 to 4 The following sheets were disposed such that single layers of each were arranged in an alternating manner: (i) graphite sheets measuring approximately 210 mm×260 mm and being 20 μm to 50 μm in thickness; and (ii) PET sheets measuring approximately 210 mm×260 mm and being approximately 10 μm in thickness. Five layers of the graphite sheets and four layers of the PET sheets were disposed, such that the graphite sheets served as the outward-most layers. Pressure (3 MPa) and heat (270° C.) were applied simultaneously to the stack thus produced, such that the layers were bonded to each other. In this way, a graphite laminate made of five graphite layers and four resin layers was obtained. Note that the graphite sheets were sheets obtained in a manner similar to that of Production Example 1.

The graphite laminate was cut with use of a laser under the processing conditions indicated in Tables 1 and 2 (described later), so as to obtain the processed graphite laminates of Examples 2 to 12 and Comparative Examples 2 to

4. The processing point output power was measured with use of a FieldMAXII-TOP manufactured by Coherent Inc.

Evaluation Method

Under the processing conditions described later, a laser was used to cut each graphite laminate along the contour thereof, so as to obtain an outer perimeter of approximately 170 mm. The amount of time required to carry out this cutting was measured. The laser processing speed was then calculated by dividing (a) the length of the outer perimeter after cutting by (b) the time required for cutting. Evaluation of whether or not cutting was possible is shown under the item “Laser processing possible?”.

Laser-processed portions of both the surface on which the laser was incident and the opposite surface were observed with a microscope. The width of regions which had turned black in color was measured. Regions which had turned black in color are referred to as scorched portions. Scorched portions were evaluated as follows.

Very Good (VG): No scorched portions.
Good (G): A small scorched portion of less than 100 μm exists.
Fair (F): A scorched portion of not less than 100 μm and less than 300 μm exists.
Poor (P): A large scorched portion of 300 μm or greater exists.

Laser-processed portions were viewed with a microscope to observe the size of burrs. Burr size was evaluated as follows.

Good (G): Burrs created were less than 150 μm.
Fair (F): Burrs created were not less than 150 μm and less than 250 μm.
Poor (P): Burrs created were 250 μm or greater.

Results of Evaluation

Tables 1 and 2 show processing conditions used for the processed graphite laminates and the results of evaluation.

TABLE 1

| | | Ex. 2 | Ex. 3 | Ex. 4 | Ex. 5 | Ex. 6 | Ex. 7 | Ex. 8 |
|---|---|---|---|---|---|---|---|---|
| Processing | Laser type | YAG | YAG | YAG | YAG | YAG | YAG | YAG |
| conditions | Laser wavelength (nm) | 1064 | 1064 | 1064 | 1064 | 532 | 532 | 532 |
| | Processing point | 13 | 13 | 13 | 14 | 4 | 6 | 18 |
| | output power | | | | | | | |
| | Beam diameter (μm) | 50 | 50 | 50 | 25 | 40 | 50 | 20 |
| Evaluation | Laser processing | Yes | Yes | Yes | Yes | Yes | Yes | Yes |
| | possible? | | | | | | | |
| | Laser processing | *1 | *1 | *1 | 20 | *2 | 2 | 75 |
| | speed (mm/s) | | | | | | | |
| | Scorched portions | F | F | F | F | VG | VG | G |
| | Burrs | F | F | F | F | G | G | G |

TABLE 2

| | | Ex. | Ex. | Ex. | Ex. | Comp. | Comp. | Comp. |
|---|---|---|---|---|---|---|---|---|
| | | 9 | 10 | 11 | 12 | Ex. 2 | Ex. 3 | Ex. 4 |
| Processing | Laser type | YAG | YAG | YAG | YAG | CO₂ | CO₂ | CO₂ |
| conditions | Laser wavelength (nm) | 532 | 532 | 355 | 355 | 10600 | 10600 | 9300 |
| | Processing point | 30 | 65 | 4 | 8.5 | 50.0 | 30 | 20 |
| | output power | | | | | | | |
| | Beam diameter (μm) | 32 | 32 | 40 | 7 | 300 | 200 | 200 |
| Evaluation | Laser processing | Yes | Yes | Yes | Yes | No | No | No |
| | possible? | | | | | | | |
| | Laser processing | 50 | 175 | *3 | 40 | — | — | — |
| | speed (mm/s) | | | | | | | |
| | Scorched portions | VG | G | VG | VG | — | — | — |
| | Burrs | G | G | G | G | — | — | — |

Note:
In the above tables, “Ex.” stands for “Example”, and
“Comp. Ex.” stands for “Comparative Example”.
*1: Laser processing speed was not measured but is inferred as being not less than 2 mm/s and less than 20 mm/s.
*2: Laser processing speed was not measured but is inferred as being less than 2 mm/s.
*3: Laser processing speed was not measured but is inferred as being not less than 20 mm/s and less than 40 mm/s.

As can be seen from Tables 1 and 2, it was found that processing of the graphite laminates was possible when using a laser having a wavelength of not less than 10 nm and not more than 1100 nm. Furthermore, scorched portions and burrs were prevented or reduced particularly when using a laser having a wavelength of not less than 300 nm and not more than 600 nm.

Although the disclosure has been described with respect to only a limited number of embodiments, those skilled in the art, having benefit of this disclosure, will appreciate that various other embodiments may be devised without departing from the scope of one or more embodiments of the invention should be limited only by the attached claims.

### REFERENCE SIGNS LIST

1, 10: Processed graphite laminate
11: Graphite layer
12: Resin layer

1. A method of producing a processed graphite laminate, comprising a step of:
cutting a graphite laminate with use of a laser,
wherein the graphite laminate includes two or more graphite layers, and a resin layer that is provided between the two or more graphite layers,
wherein each of the two or more graphite layers have a thickness of not less than 10 μm and not more than 100 μm, and
wherein the laser has a wavelength of not less than 10 nm and not more than 1100 nm.

2. The method according to claim 1, wherein the wavelength of the laser is not less than 300 nm and not more than 600 nm.

3. The method according to claim 2, wherein the laser has a processing point output power of not less than 4 W and not more than 70 W.

4. The method according to claim 2, wherein the laser has a beam diameter of not less than 5 μm and not more than 50 μm.

5. The method according to claim 1, wherein the resin layer is a thermoplastic resin layer.

6. A processed graphite laminate comprising:
two or more graphite layers; and
a resin layer that is provided between the two or more graphite layers,
wherein each of the two or more graphite layers have a thickness of not less than 10 μm and not more than 100 μm, and
wherein the two or more graphite layers each have an end part which is at least partially covered with one or more of the group consisting of a resin, a carbonized material, and a graphitized material.

7. The processed graphite laminate according to claim 6, wherein the resin layer is a thermoplastic resin layer.

8. The processed graphite laminate according to claim 7, wherein the thermoplastic resin layer is a thermoplastic polyester resin layer.

9. The method according to claim 3, wherein the laser has a beam diameter of not less than 5 μm and not more than 50 μm.

10. The method according to claim 2, wherein the resin layer is a thermoplastic resin layer.

11. The method according to claim 3, wherein the resin layer is a thermoplastic resin layer.

12. The method according to claim 4, wherein the resin layer is a thermoplastic resin layer.
